(19) United States
(12) Patent Application Publication
(10) Pub. No.: US 2002/0042919 A1
(43) Pub. Date: Apr. 11, 2002

(54) Method for utilizing excess communications capacity

(76) Inventors: Mark Alan Sturza, Encino, CA (US); Thomas Nello Giaccherini, Carmel Valley, CA (US); James Riley Stuart, Louisville, CO (US)

Correspondence Address: Anglin & Giaccherini, Post Office Box 1146, Carmel Valley, CA, 93924, US

(21) Appl. No.: 09/833,094

(22) Filed: Apr. 10, 2001

Related U.S. Application Data
(63) Continuation-in-part of application No. 09/579,324, filed on May 25, 2000.
(63) Continuation-in-part of application No. 09/688,997, filed on Oct. 16, 2000.

(51) Int. Cl. H04N 7/20; H04N 7/173

(52) U.S. Cl. 725/67; 725/96

(57) ABSTRACT

Methods and apparatus for the secure and copy-proof distribution of data are disclosed. In a preferred embodiment of the invention, a network of satellites in low Earth orbit are used to convey packets of data from ground stations to set-top boxes installed in residences. The data is conveyed from the ground stations and to the set-top boxes during times when the network capacity is not fully utilized. In one embodiment, the packets of data which are transmitted from the ground stations to the satellites, and then to the subscribers, are heavily encrypted. In one embodiment, this data is always confined to the secure network, and is never introduced to the Internet or other public networks. The data conveyed by the present invention may be video or audio programming, business data, or any other type of information. Upon arrival at the subscriber's premises, the received signals may be decrypted, but are not capable of being copied, since the receiver does not include any external disc or tapes drives or output ports.

### CROSS-REFERENCE TO A RELATED PENDING PATENT APPLICATION & CLAIM FOR PRIORITY

The present Patent Application is a Continuation-in-Part Application, which is related to pending U.S. patent application Ser. No. 09/579,324, filed on May 25, 2000; and to pending U.S. patent application Ser. No. 09/688,997 filed on Oct. 16, 2000. The Applicants hereby claim the benefit of priority for any and all subject matter shared by the present Application and the pending Applications filed on May 25, 2000 and Oct. 16, 2000.

### INTRODUCTION

The title of this Patent Application is Method for Utilizing Excess Communications Capacity. The Applicants, Mark Alan Sturza, 16161 Ventura Boulevard, Suite 815, Encino, Calif. 91436; Thomas Nello Giaccherini, Post Office Box 1146, Carmel Valley, Calif. 93924-1146, and Dr. James Riley Stuart, 1082 West Alder Street, Louisville, Colo. 80027-1046, are all citizens of the United States of America.

### FEDERALLY SPONSORED RESEARCH OR DEVELOPMENT

None.

### FIELD OF THE INVENTION

The present invention pertains to methods and apparatus for taking advantage of inefficiencies and excess capacities which are inherent in virtually all communications networks. More particularly, one preferred embodiment of the invention employs satellite networks to securely deliver copyrighted entertainment programming directly to homes.

### BACKGROUND OF THE INVENTION

In the past decade, many new satellite networks have been proposed. A few early systems, like Iridium^{SM} and Globalstar^{SM} have been launched, and currently provide some forms of worldwide telecommunications services. These satellites operate in low Earth orbits, and relay packets of digitized data from ground stations to customers using fixed, mobile or handheld terminals. Another satellite service called Directv^{SM} operates in geosynchronous orbit, and furnishes a continuous stream of scheduled, analog signals that carry television programs and old motion pictures to residential customers. As of April 2000, Directv^{SM} had over eight million subscribers.

None of systems provides a highly interactive, high resolution entertainment digital system that supplies first-run movies on demand and protects against copyright infringement. The development of such a system would constitute a major technological advance, and would satisfy long felt needs and aspirations in the both the entertainment and telecommunications industries.

### SUMMARY OF THE INVENTION

The present invention provides methods and apparatus for delivering data over a network at times when the network experiences less than full transmission capacity. In a preferred embodiment, a constellation of satellites in low Earth orbit receive packets of data from ground stations during these times of less than peak capacity. These packets are then conveyed to receivers over a relatively long period of time, where they are resequenced, and are then slowly accumulated on a storage device such as an array of hard drives, memory chips or other storage devices. After this “accumulation period” is completed and a full supply of data has been built up, subscribers then retrieve the data from the storage device.

The invention provides a highly secure distribution system which thwarts copyright infringement and other unauthorized copying. In one embodiment, the packets of data which are transmitted from the ground stations to the satellites, and then to the subscribers, are heavily encrypted. In one embodiment, this data is always confined to the secure network, and is never introduced to the Internet or other public networks. The data conveyed by the present invention may be video or audio programming, business data, or any other type of information. Upon arrival at the subscriber's premises, the received signals may be decrypted, but are not capable of being copied, since the receiver does not include any external disc or tapes drives or output ports. The subscriber's antenna, which captures the encrypted signals, maybe hard-wired to the receiver. The video display which is viewed by the subscriber may also be hard-wired to the receiver. The entire system may be shielded to mitigate any local radio frequency emissions. The system may also be tamper-proofed, so that any attempt to make unauthorized copies of data or to open the receiver cause an immediate erasure of all the data stored in the receiver.

Methods for delivering data from a provider to residential and other subscribers include local direct-to-home (DTH) delivery with standard and non-standard uses of existing communications channels. VHF and UHF television broadcast, AM broadcast and FM broadcast stations are usable for delivery of data to subscribers. Data signals may transmitted directly or over cable systems to users. Additionally, there exist national, regional or long-haul data delivery methods to the local, last-mile providers, including very small aperture (VSAT) satellite communications channels.

An appreciation of the other aims and objectives of the present invention and a more complete and comprehensive understanding of this invention may be obtained by studying the following description of a preferred embodiment, and by referring to the accompanying drawings.

### A BRIEF DESCRIPTION OF THE DRAWINGS

FIG. 1 is an illustration which show the transfer of data from a terrestrial gateway to a low Earth orbit satellite, and then to residential and other subscribers.

FIG. 2 is a schematic depiction of the equipment that is provided to customers including a hard-wired apparatus comprising a roof-top antenna, a set-top box and a wide-screen, flat-panel display.

FIG. 2A is a flow diagram illustrating the steps by which a customer requests program material which is processed, sent via selected network from the source to the customer's set-top box for customer viewing.

FIG. 3 is a schematic depiction of the Method for Utilizing Excess Communications Capacity of communications networks showing how programing material destined for users is interspersed with other information carried by a network.

FIG. 4 is a schematic diagram which shows how data is transferred to a user via satellite, terrestrial and wireless distribution systems.

FIG. 5 is a schematic diagram which shows further details of the data encryption systems at both the distribution data system and the customer's system.

FIG. 6 presents a pictorial diagram of a tracking antenna system used by the present invention at a customer's receiving site to receive distributed data signals from a satellite or aircraft source.

FIG. 7 is a pictorial diagram of a fixed antenna used by the present invention at a customer's receiving site to receive data signals from a fixed, wireless distribution source.

FIG. 8 shows a schematic diagram ofthe principal equipment at a customer's site, a set-top box and wide screen display, and indicating the physical security employed.

FIG. 9 depicts a block diagram of the set-top box, particularly showing a tamper-proof exterior box and secure input/output connections.

FIG. 10 depicts principal equipment at a customer's site with no physical security, and relying therefore, on encrypted transmissions and storage end-to-end.

FIG. 11 reveals in schematic form how the present invention reacts to specific customer requests by retrieving and transmitting requested data.

FIG. 12 is a block diagram showing how each customer system contains layered and user-specific encryption/decryption features for the provided services of conventional digital data, video, audio, etc.

FIG. 13 shows in block diagram form the multiple levels of encryption, decryption and optional security available in the instant invention.

FIG. 14 is a list of functions embodied in the present invention, presented in blocks as a convenient catalogue of system server functions.

FIG. 15 is a block diagram of the customer specific, application specific integrated circuit (ASIC) for encryption, decryption and display of data at a customer's site. It shows that no digital, decrypted data is available external to the ASIC which prevents copying the digital data.

FIG. 16 is a block diagram of an application specific integrated circuit (ASIC) for handling service requests and responses at a customer's site.

FIG. 17 is a schematic diagram illustrating the “Rainbarrel” data delivery scheme of the present invention. In this method, requested data is delivered to a customer in packets which are reassembled and “drip” into storage at the customer's site over a period of time.

FIG. 18 is a list of steps which occur when a customer requests data from the system server.

FIG. 19 is a flow diagram depicting the steps by which digital product stored at the system server is delivered through a selected network to a customer's site.

FIG. 20 is a flow diagram illustrating the steps by which a user requests a system menu.

FIG. 21 is a list of steps which occur when a customer requests system data from a system menu.

FIG. 22 is a block diagram of the circuit board in the customer's set-top box illustrating the functions, inputs and outputs of the circuit board.

FIG. 23 presents a partial cross-section ofthe exterior tamper-proof container of the set-top box, indicating a typical fastener switch which causes an erasure of all digital data stored in the box when the fastener is removed (as by tampering).

### A DETAILED DESCRIPTION OF PREFERRED & ALTERNATIVE EMBODIMENTS

The present invention comprises methods and apparatus for delivering high quality digital signals to residential or other subscribers using the unused, excess capacity that is inherent in virtually all communication networks. In one preferred embodiment of the invention, satellites in low Earth orbit are employed to relay signals from a terrestrial gateway to subscribers in short bursts during the time that a satellite experiences underused capacity.

In other preferred embodiments, data may be delivered to subscriber's by direct transmissions from AM broadcast, FM broadcast, terrestrial VHF and UHF television stations or Direct-to-Home satellite systems. The methods of delivery are described in further detail below.

### General Description

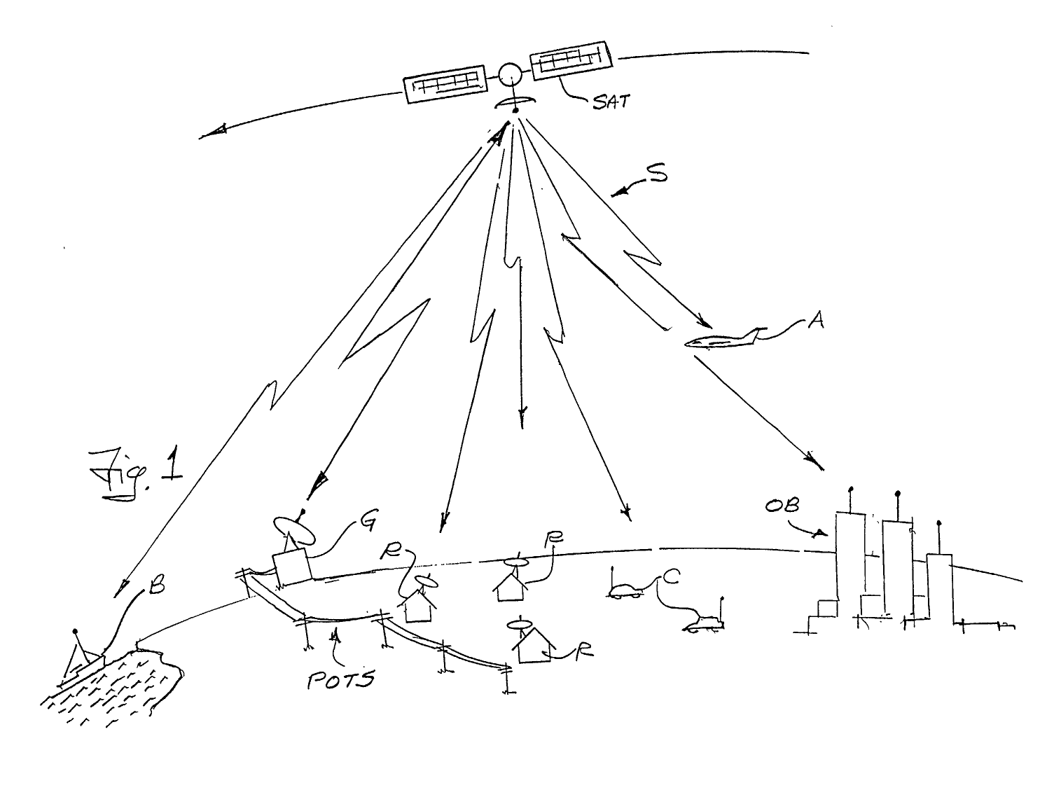

FIG. 1 generally illustrates the embodiments of the present invention which employ satellites SAT. A satellite SAT in Earth orbit is capable of communicating with a ground station G. The ground station G is connected to a terrestrial network, such as a public switched telephone network POTS. When a satellite SAT experiences a period of time when all its capacity is not utilized, the satellite SAT can request an upload of data from the ground station G. The ground station G then sends packets of data to the satellite SAT in short bursts. The satellite SAT is capable of delivering packets of data to many different types of terminals, including residences R, office buildings OB, cars and other vehicles C, aircraft A and boats B.

In another embodiment, the invention may be utilized to transmit signals S to a wide variety of terminals, including cellular phones, personal digital assistants, portable computers and displays, or other intelligent appliances.

In these embodiments, digitized, heavily-encrypted packets are beamed up to the satellite SAT from a ground station G that stores an electronic, digital copy of a copyrighted first-run motion picture. In one embodiment, the transfer of packets is accomplished using asynchronous transfer methods, and the packets are then routed to, and resequenced in order at their final destination.

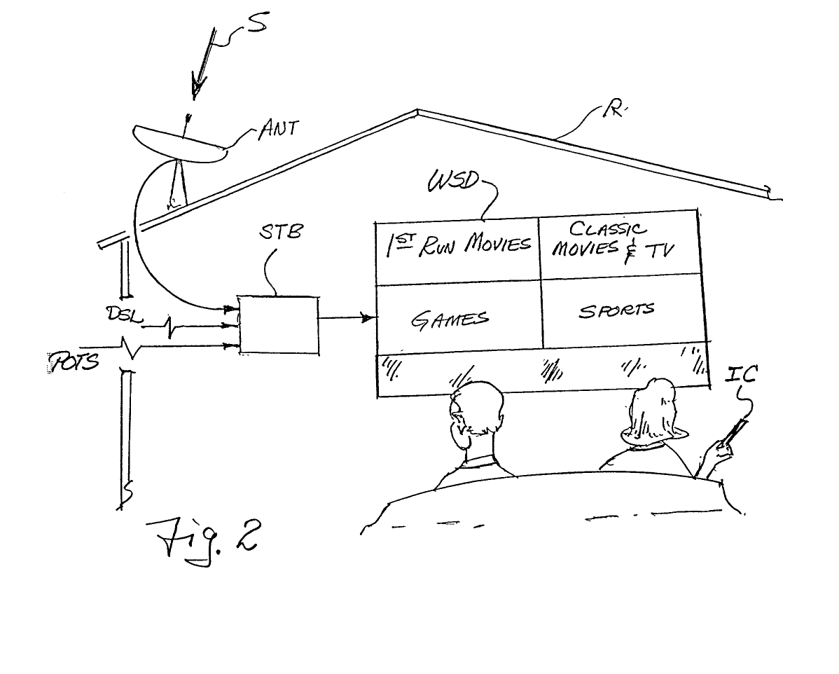

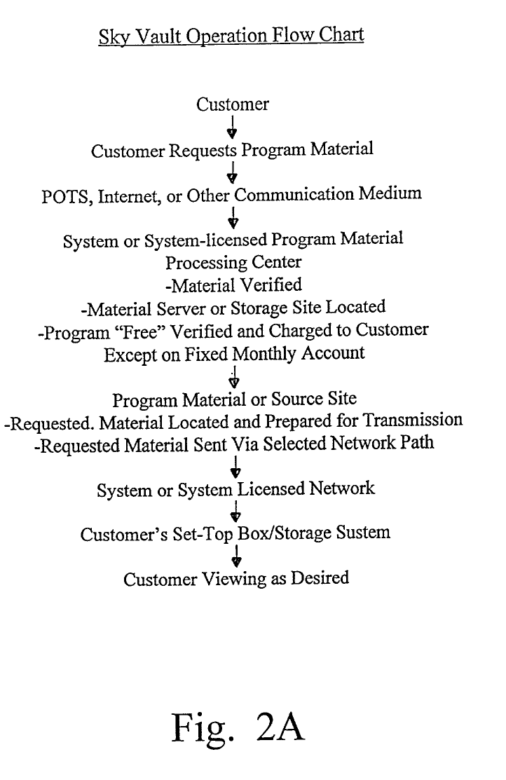

FIG. 2 is a schematic depiction of the equipment that is provided to the customer's site, including a hard-wired apparatus comprising a roof-top antenna ANT, a set-top box STB and a wide-screen, flat-panel display WSD. FIG. 2A is a flow diagram illustrating the steps by which a customer requests program material which is processed, sent via selected network from the source to the customer's set-top box STB for customer viewing. As shown in FIG. 2, the encrypted packets are received by an active beam steering antenna ANT at the subscriber's premises R, and are stored in the set-top box STB which includes a large dual-partitioned array of computer hard drives. The set-top box STB is hard-wired to the wide screen display WSD.

FIG. 3 is a schematic depiction of the Method for Utilizing Excess Communications Capacity of communication networks showing how programing material destined for customers is interspersed with other information carried by a network.

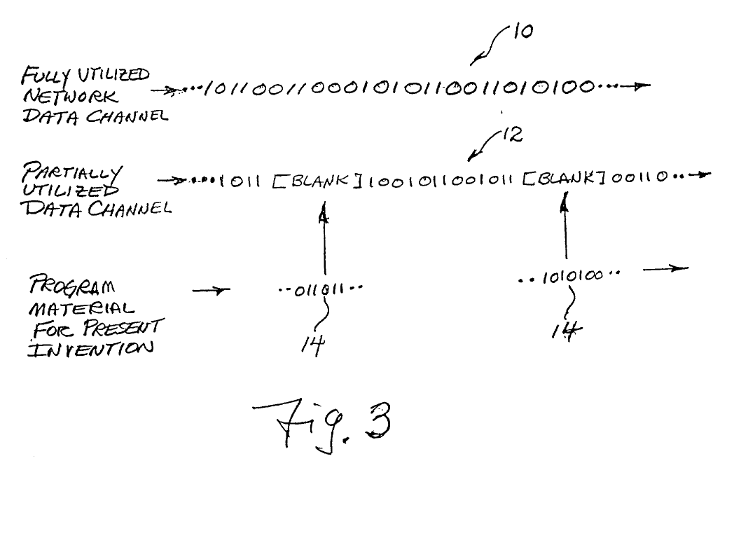

FIG. 4 is a schematic diagram which shows how data is transferred to a customer via satellite, terrestrial, and wireless distribution systems.

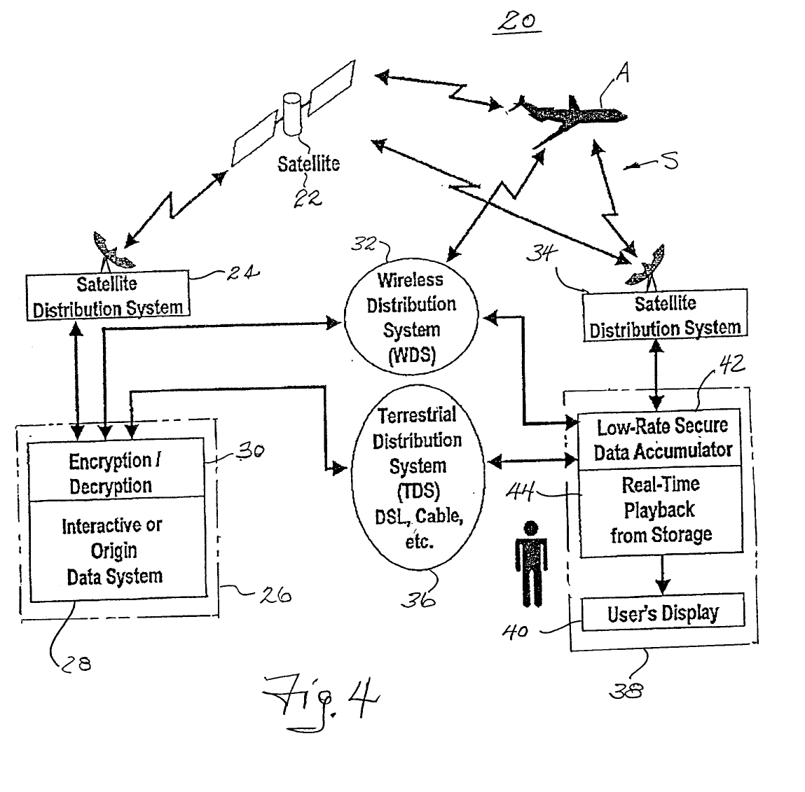

FIG. 5 is a schematic diagram which shows further details of the data encryption systems at both the distribution data system and the customer's component system. Packets may be received by the set-top box STB in very small increments over long periods of time. These incoming packets are stored in one partition 42 of the two partitions 42, 44 in the set-top box STB. The second partition 44 is used to supply on-demand unlimited-view programming while the first partition 42 is filled incrementally. In one embodiment ofthe invention, programming is routed to the first partition 42 over a one week period while the second partition 44 is used for viewing. At the end of the one week period, the functions of the partitions 42, 44 are exchanged. The “old” programming on the second partition 44 is then replaced with the next weeks' fare, while the current programming is viewed using the first partition 42. This “rain-barrel” method of incrementally transporting data to a large storage device enables the utilization of the under-used capacity of a satellite network.

The novel use of this method of distribution to a storage device which is securely integrated with a viewing apparatus provides secure distribution and viewing of copyrighted data. In one embodiment of the invention, the bulk of the download of programming from the satellite SAT to the set-top box STB occurs during bursts that take place at night, when normal network traffic dwindles to levels far below peak day-time usage. FIG. 3 illustrates how the programming material is interspersed with gaps in network traffic.

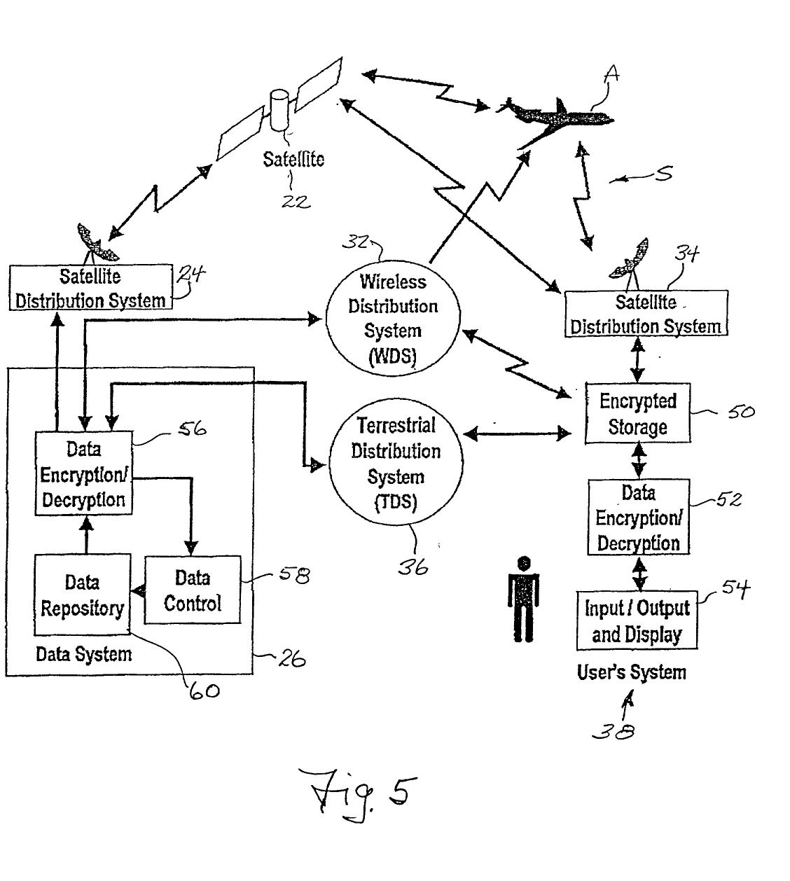

In an embodiment which utilizes wireless networks, a roof-top receiver is installed at the subscriber's premises to capture signals broadcast from the satellites or other wireless source. In one embodiment of the invention, the receiver is coupled to a phased-array antenna which uses active beam steering to track the satellites as they move across the sky. FIG. 6 presents a pictorial diagram of a tracking antenna system 70 used by the present invention at a customer's receiving site R to receive distributed data signals S from a satellite SAT or aircraft A source.

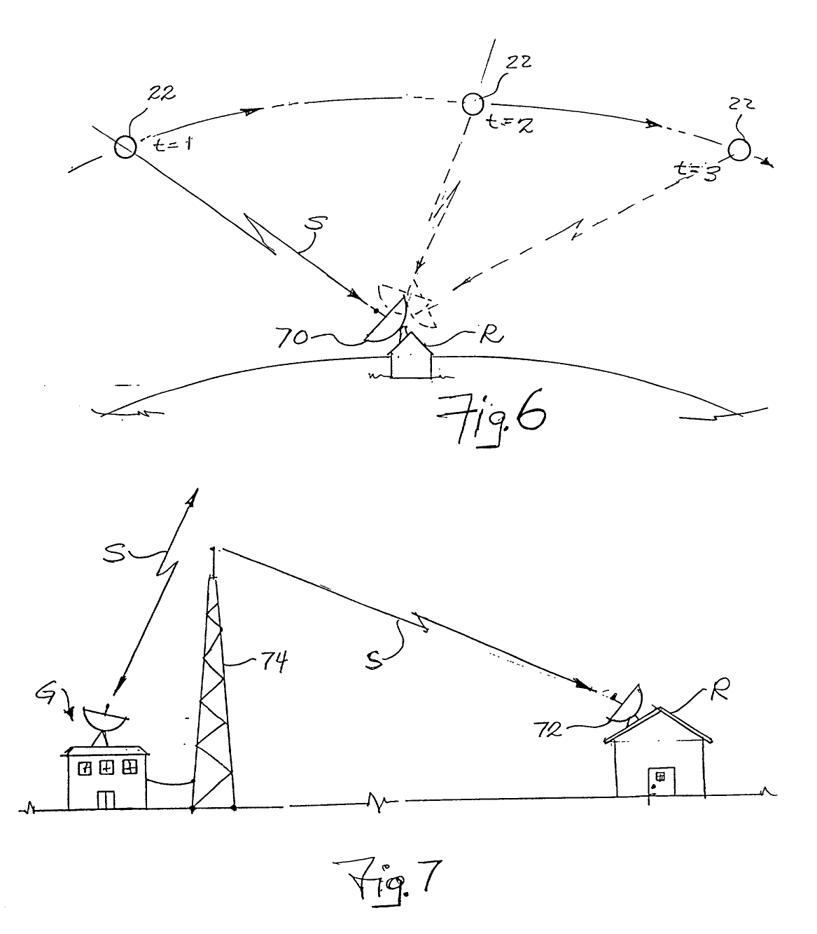

Another embodiment of the invention incorporates a passive, directional or omni-directional antenna. FIG. 7 is a pictorial diagram of a fixed antenna 72 used by the present invention at a customer's receiving site R to receive data signals S from a fixed, wireless distribution source G such as a terrestrial television station, AM broadcast or FM broadcast station. A high-gain dish antenna 72 is depicted in the Figure, but the reader will appreciate that any antenna, outdoor or indoor, capable of receiving wireless signals maybe used depending on the wireless transmission source.

### Data Delivery Methods on Existing Communications Channels

Methods for delivering data from a provider to the encrypted storage device 50 of a residential and other subscriber include local direct-to-home (DTH) delivery with standard and non-standard uses of existing communications channels. Additionally, there exist national, regional or long-haul data delivery methods to local, last-mile sources or providers, including very small aperture transmission (VSAT) satellite communications channels.

### Local Standard Data Delivery Methods

Referring to FIGS. 1, 2, 4, 5, 6 and 7, several direct-to-home (DTH) data delivery methods exist which use standard broadcast transmissions over existing communications channels and networks. Some of these are Very High Frequency (VHF) and Ultra High Frequency (UHF) Television Broadcast Channels, Amplitude Modulation (AM) Broadcast Station Channels, Frequency Modulation (FM) Broadcast Station Channels, Satellite Television Receive Only (TVRO), Satellite Direct Broadcast Systems (DBS, DSS, or DTH), and Cellular Digital Packet Data (CDPD). Data signals may be received directly by a subscriber on his/her wireless antenna, or through a cable system.

VHF and UHF Television Broadcast Channels: The television (TV) broadcast bands in the United States operate on frequencies from 54 to 88 MHz, 174 to 216 MHz and 470 to 806 MHz. These frequency bands are divided into 68 channels of 6 MHz bandwidth each. The channel center frequencies in MHz, where n is the channel number are given by:

f₀=57+(n−2)×6 MHz for n=2 to 6 Equation (1)

f₀=177+(n−7)×6 Mhz for n=7 to 13 Equation (2)

f₀=473+(n−14)×6 Mhz for n=14 to 69 Equation (3)

In the United States, Code of Federal Regulations 47 CFR 73.646 authorizes broadcast TV stations to provide telecommunications services within a visual signal, including bulk data distribution on a broadcast basis. An encoder at the TV station inserts digital data 10 into the 525 lines of a U.S. national standard (NTSC) system, or the 625 lines of a system such as the European television standard system (PAL) or the French television standard system (SECAM), popular in Asia. The data 10 replaces the television picture. A decoder module STB removes the data 10 for viewing at the viewer's display WSD.

The Internet Society standard, RFC2728, entitled “The Transmission of Internet Protocol (IP) Over the Vertical Blanking Interval of a Television Signal”, is used in this invention for transmitting data to a subscriber. Each video line is encoded with North American Basic Teletex Specification (NABTS) data packets. The data contained in these sequential, ordered packets, form a serial data stream on which a framing protocol indicates the location of IP packets, having compressed headers, and containing the data. The NABTS packet is a 36-byte structure encoded on a single video line, resulting in a raw bit rate of 9.072 Megabits per second (Mbps) for a NTSC system and 10.8 Mbps for a PAL or SECAM system. A two-byte “Clock Synchronization” signal and one-byte “Byte Synchronization” signal occur at the beginning of every line containing a NABTS packet. They are used to synchronize the decoding sampling rate and the byte timing. A three-byte packet address, one-byte continuity field, one-byte flag field, and 28-bytes of data payload complete the packet structure.

A Serial Line Internet Protocol (SLIP) for framing is used to encapsulate the NABTS packets, abstracting the data from the lower protocol layers. UDP/IP header compression is used to maximize bandwidth efficiency.

Due to the unidirectional nature of Vertical Blanking Interval (VBI) data transport, forward error correction (FEC) is needed to ensure the integrity of data at the television receiver. Two bytes of the 28 data bytes in each packet are used for FEC, as are two of every sixteen packets. The resulting code rate is 13/16. The data transmission rate is 75 GBytes per day for a NTSC system and 92 GBytes per day for a PAL or SECAM system. In a market such as Los Angeles, Calif. which has seven VHF and five UHF television stations, the data transmission capacity can be increased further by a factor of twelve. If all of the Los Angeles television stations were used 24 hours per day, the effective data transmission rate would be nearly one terabyte per day.

AM Broadcasting Station Channels: The amplitude modulation (AM) radio broadcast band in the US ranges from 535 to 1705 kHz. It is divided into 117 channels of 10 kHz bandwidth each. Center frequencies in kHz are given by:

f₀=540+n×10 kHz for n=0 to 116 Equation (4)

AM broadcasting stations transmit at 50 kilowatts. In the US, 47 CFR 73.127 authorizes AM broadcast stations “to transmit signals not audible on ordinary consumer receivers, for both broadcast and non-broadcast purposes.”

One implementation of data delivery using AM broadcasting stations is a subcarrier at the channel center frequency modulatedby a 256-Quadrature Amplitude Modulation (QAM) waveform, with shape factor 1.25, at 8 kilobits per second (kbps). This provides a 64 kbps transmission rate of raw data. The symbols are trellis-coded at rate ⅞ to provide FEC, resulting in a data rate of 56 kbps. The data is partitioned into 512 byte (4,096 bit) packets. The first 16 bytes of each packet are used for synchronization, address and flag fields. The remaining 496 bytes contain data. The resulting data transmission rate is 64.25 kbps, or 585.9 MBytes per day for each AM radio station.

FM Broadcast Station Channels: The frequency modulation (FM) broadcast band in the US ranges from 88 to 108 Mhz. The band is divided into 100 channels of 200 kHz bandwidth each. The channel center frequencies are given by:

f₀=88.1+n×0.2 MHz where n=0 to 99 Equation (5)

In the U.S., 47 CFR 73.293 authorizes FM broadcast stations to “transmit subcarrier communications services.” One implementation of data delivery using FM radio broadcasting stations is a subcarrier at the channel center frequency modulated by a shaped-offset, Quadraphase Shift Keying (QPSK) waveform, with shape factor of 1.25, at 80 kbps. This provides a 160 kbps transmission rate of raw data. The delivered data is partitioned into 512 byte (4,096 bit) packets. The first twelve bytes of each packet are used for synchronization, address and flag fields. The remaining 500 bytes contain payload data with rate ⅘ turbo code, FEC. The resulting data transmission rate is 125 kbps, or 1.36 gigabytes (GBytes) per day for one FM broadcasting station.

Satellite TV, TVRO: In the United States, Satellite TV operates in the C-band (3.7-4.2 GHz) and in the Ku-band (11.7-12.2 GHz), Fixed Satellite Service (FSS) allocations. These are so-called “big dish” systems. One implementation of data delivery using Satellite Television Receive Only (TVRO) transmissions uses the same scheme described above for the VHF and UHF television broadcast stations.

Satellite DBS, DSS or DTH: The Direct Broadcast Satellite Service band in the United States ranges from 12.2 to 12.7 GHz. The DIRECTV™ system provides up to 30 Mbps of FEC-protected data, depending on the code rate selected for each transponder. Each transponder typically provides three to eight video channels, depending an content. One entire transponder used for transmitting data in the present invention would provide 324 GBytes of data per day.

Cellular CDPD: The Cellular Digital Packet Data (CDPD) network provides digital data over existing North American cellular networks by taking advantage of the idle time on analog AMPS channels to transmit packet data at 19.2 kbps. There are 666 AMPS channels between 870 and 890 MHz in the forward direction, and between 825 and 345 MHz in the reverse direction. The channels have 30 kHz bandwidths. There are 42 radio frequency (RF) control channels which cannot be used for CDPD. The data is Gaussian Minimum Shift Keying (GMSK) modulated with a bandwidth time product (BT) of 0.5. CDPD supports two-way communication, so only minimal FEC is required. Allowing 1.2 kbps for packet overhead and FEC, there remains eighteen kbps for data transmission, or 194 MBytes of data per day, per cellular channel used.

### Local Non-Standard Data Delivery Methods

Referring again to FIGS. 1, 2, 4, 5, and 7, at least four possible local, direct-to-home (DTH) data delivery methods exist based on non-standard uses of existing communications channels and networks. These are: Television Vertical Blanking Interval (VBI); Television Aural Band Subcarriers; AM Subcarriers; and FM Subcarriers. These signals may be received directly by a subscriber on his/her wireless antenna, or through a cable system.

Television Vertical Blanking Interval (VBI): The TV band allocations are discussed above. In the US, 47 CFR 73.646 authorizes broadcast TV stations to provide telecommunications services on the VBI, and in the visual signal, including bulk data distribution on a broadcast basis. A VBI encoder at the TV station inserts digital data into the 16 video lines corresponding to the VBI. These are lines 10-25 in a 525-line system such as NTSC, or lines 7-22 in a 625-line system such as PAL or SECAM. The insertion has no impact an the TV picture. A decoder module STB removes the data at the viewers display WSD.

As with the standard method for data delivery by TV, the Internet Society standard RFC2728, is used for transmitting data. The VBI lines are encoded with North American Basic Teletex Specification (NABTS) packets. The data contained in these sequential, ordered packets, form a serial data stream on which a framing protocol indicates the location of IP packets, with compressed headers, containing the data.

The NABTS packet structure and synchronization signals have already been described above. The SLIP framing protocol used to encapsulate the NABTS packets, UDP/IP header compression used to maximize bandwidth efficiency is likewise discussed above. As in the data delivery methods based on standard uses of existing communications channels, Forward Error Correction (FEC) is needed to ensure the integrity of data at the receiver. Two bytes of the 28 data bytes in each packet are used for FEC, as are two of every sixteen packets. With the resulting code rate of 13/16, and the data transmission rate of 13.65 kbps per line and 218.4 kbps for all 16 lines, a total of 2.36 GBytes of data per day can be transmitted from one TV station.

However, all 16 VBI lines may not be available. For example, line 21 is used in the United States for closed-captioning. However, when the TV station is not sending a TV picture, all of the lines could be used for data.

TV Aural Band Subcarriers: In the U.S., 47 CFR 73.665 authorizes the transmission of subsidiary services on subcarriers of TV signals and other signals in the composite baseband, 0 to 120 kHz, .

AM Subcarriers: In the U.S., 47 CFR 73.127 authorizes AM broadcast stations to transmit subcarriers.

FM Subcarriers: 47 CFR 73.293 authorizes FM broadcast stations to “transmit subcarrier communications services in the United States.” Broadcast FM stations have been using subcarriers since the 1950's for things like Muzak music delivered to individual and company subscribers. Data broadcasting is more recent, but already in use for things like differential Global Positioning System (GPS) corrections, traffic data, stock quotes, etc.

One implementation of data delivery by FM subcarrier is the Radio Broadcast Data System (RBDS). A 57 kHz subcarrier is used, which is amplitude modulated by shaped biphase, differentially-coded, encoded digital data at 1.1875 kbps. The baseband data is packetized into groups of 104 bits. Each group is divided into 4 blocks of 26 bits each, and each block is further divided into 18 data bits and 10 check bits. This results in a 0.615 code rate, and a 730.8 bps information rate. Data transmission of this type is 7.9 MBytes per day.

Another implementation is Data Radio Channel (DARC). A 76 kHz Level Minimum Shift Keying (LMSK) subcarrier, modulated at 16 kbps raw bit rate, is injected into the composite FM signal at 10% modulation (−20 dB). The 16 kbps raw bit rate is equivalent to 173 MBytes per day. Adding frame and address overhead at 20%, and rate_forward error correction, a data rate of 10 kbps, or 108 MBytes per day can be achieved. A more efficient modulation scheme can provide a 56 kbps raw bit rate, equivalent to a 35 kbps data transmission rate, or 378 MBytes of data delivery per day per FM station.

### National or Regional Long-Haul Data Delivery Method (VSAT)

FIG. 5 depicts satellite delivery of data to national or regional destinations. Long-distance data delivery to local, “last-mile” data sources such as shown in FIG. 7. Such data delivery is implemented by leasing existing Low Earth Orbiting Satellite VSAT communications channels. For example, a 10 MHz subcarrier slice of the capacity of a single transponder covering the United States on a pre-emptible basis is both inexpensive and readily available. In the U.S., Satellite VSAT operates in the C-band (3.7-4.2 GHz) and Ku-band (11.7-12.2 GHz) Fixed Satellite Service (FSS) allocations.

Data transmission rates for transponders was described above in the section discussing the Direct Broadcast Satellite Service.

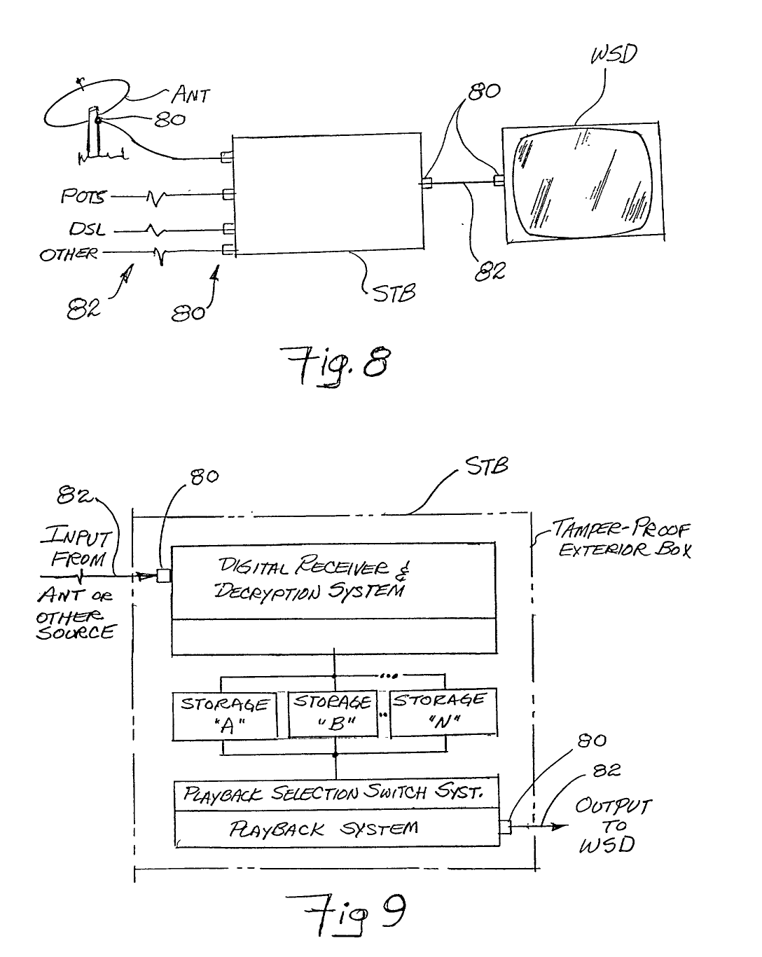

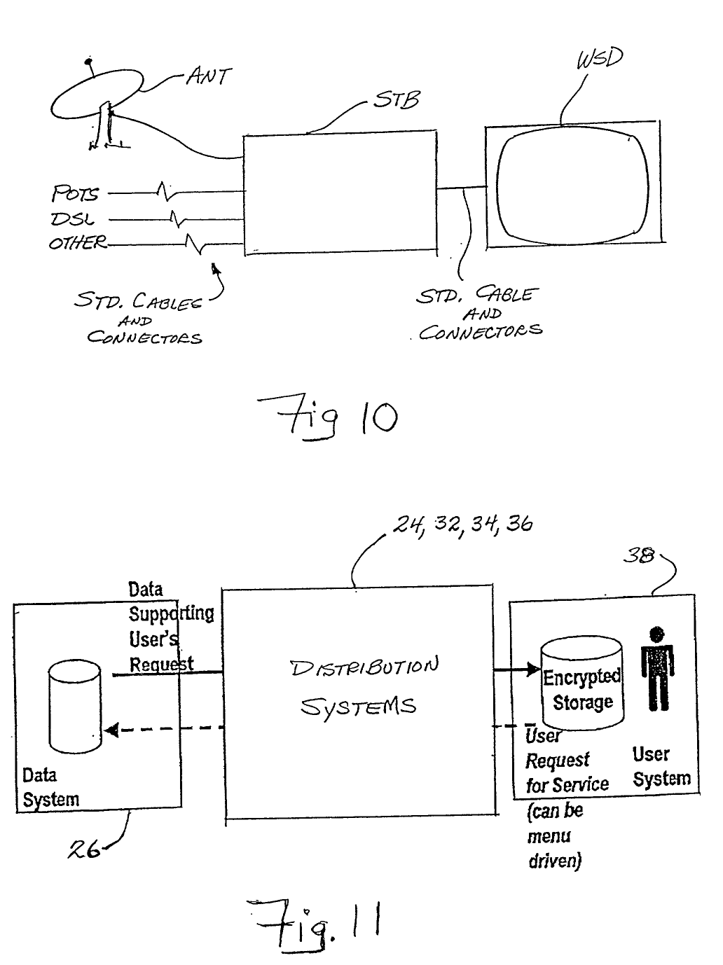

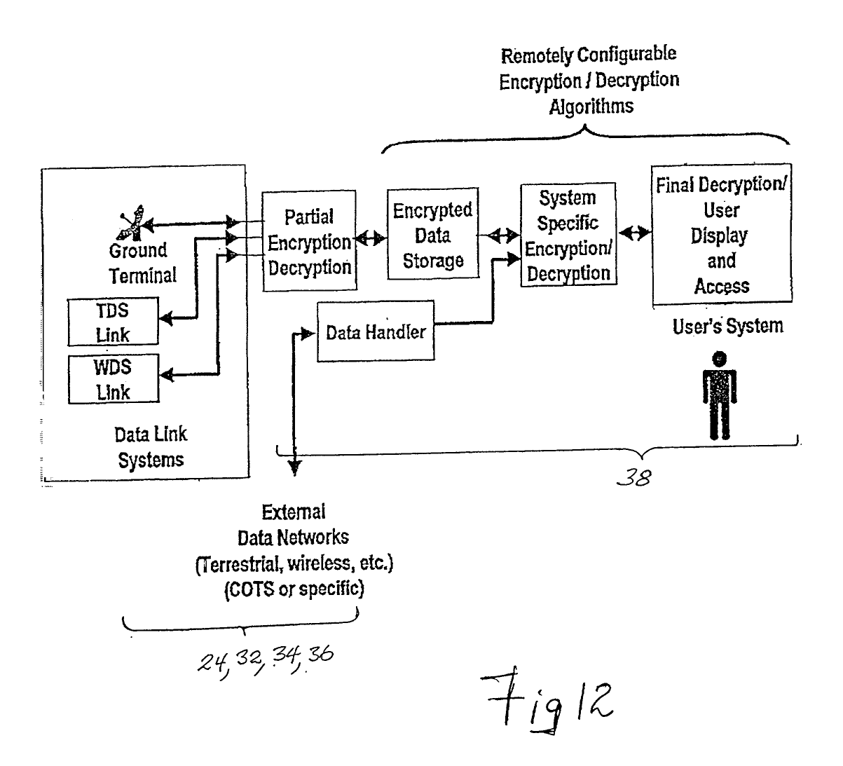

FIG. 8 shows a schematic diagram of the principal equipment at a customer's site: antenna ANT, set-top box STB and wide screen display WSD. It indicates the physical security employed in one embodiment. FIG. 9 depicts a block diagram of the set-top box STB, particularly showing a tamper-proof exterior box and secure input/output connections 80, 82. FIG. 10 depicts principal equipment at a customer's site with no physical security, which relies therefore, on encrypted transmissions and storage end-to-end. The antenna ANT is hard-wired to the set-top box STB which functions as both a receiver, decryption device and storage system. The set-top box STB contains an array of computer hard drives configured in two partitions 42, 44 for storing data. In an early embodiment of the invention, the hard drive array will have a capacity of about 100 to 200 Gb. The set-top box STB, in turn, is hard-wired to a large, high-resolution flat screen WSD that is configured in a motion picture aspect ratio. The flat screen WSD may incorporate home-theater quality speakers. Table 1 below presents the attributes and operation of physical security of the data sent to the set-top box STB.

TABLE 1
Tamper-Proof Attributes and Operation
of Set-Top Box Physical Security

| Action/Component | STB Power “ON” | STB Power “OFF” |
|---|---|---|
| Connector removed | Immediate “erase” | Non-alterable “erase” |
| or fasteners removed | signal sent to all | signal stored in non- |
| from STB access | program storage | volatile memory. All |
| panels | systems. | storage systems erase |
| | | immediately when |
| | | power returns. |

Attributes:
(1) Special “secure” connections between the inputs and outputs to the set-top box.
(2) Access to internal circuitry of the set-top box is prevented by unique screw switches on closure and panel retention fasteners.

The set-top box STB has no external ports, jacks, floppy-disc, tape or CD drives. All the cables 82 between the antenna, the set-top box, wide screen display and speakers are hard-wired, heavily shielded and tamper-proofed to thwart copying or piracy of the programs. The receiver is “booby-trapped,” so that any attempt to open the box by removing screws or by cutting a hole to attempt to make unauthorized copies triggers the immediate erasure of all data from the hard drives, incapacitates the set-top box and maybe capable of reporting the tampering to the program provider over an Internet connection. Table 2 below lists several system security options.

TABLE 2
System Security Options

| | |
|---|---|
| Physical System Protection | Secure network. |
| with no Encryption | Tamper proof equipment on customer |
| | premises. |
| | Tamper proof connections between all |
| | customer equipment components. |
| Physical System Protection | Secure or open network |
| with Encrypted Transmission | Tamper proof equipment on customer |
| Only | premises. |
| | Tamper proof connections between all |
| | customer equipment components. |
| Encryption Protection | Open Network. |
| End-to-End | Common commercial components |
| | System unique encryption: encrypted |
| | transmissions; encrypted storage; final |
| | decryption inside customers wide- |
| | screen display. |

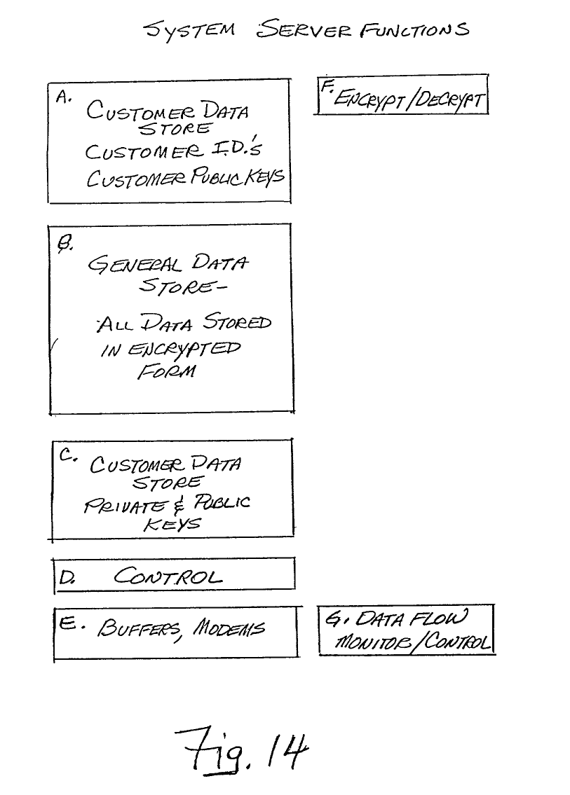

FIG. 12 is a block diagram showing how each customer system contains layered and user-specific encryption/decryption features for the provided services of conventional digital data, video, audio, etc. FIG. 13 shows in block diagram form the multiple levels of encryption, decryption and optional security available in the instant invention.

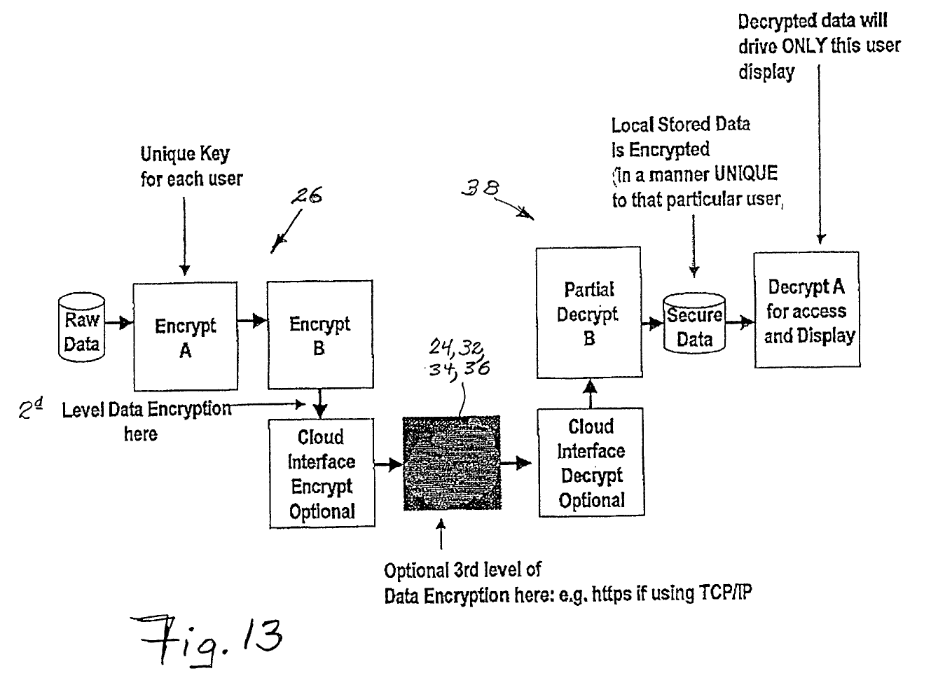

FIG. 11 reveals in schematic form how the present invention reacts to specific customer requests by retrieving and transmitting requested data. Unlike present entertainment services like Directv^{SM}, Home Box Office^{SM}, Showtime^{SM}, The Movie Channel^{SM}, Cinemax^{SM} or Starz^{SM}, one embodiment of the present invention provides immediate, on-demand programming which may be viewed an unlimited number of times at the subscriber's convenience for a monthly fee. In a preferred embodiment of the invention, the programming package includes first-run theatrical releases, which has previously been shunned by the established motion picture industry due to copyright security and piracy issues. The monthly programming may also include interactive games, sports, news, educational content, classic films and both current and vintage television selections.

While the preferred embodiment ofthe invention is specifically configured for providing revolutionary entertainment programming, the invention may be utilized to transport any kind of data during the non-peak hours or under-utilized periods of operation of a satellite network. While the preferred embodiment is described as a particular use of low Earth orbit satellite constellations, any combination of LEO, MEO, GEO or other satellites, sub-orbital platforms or any other vehicle may be employed to implement the invention. The invention is not limited to using the excess capacity of satellite systems. Due to the novel incorporation of the “rain-barrel” feature for accumulating data slowly, over a long period of time and in small increments, any network of conventional copper land-lines, fibers, broadcast or microwave towers, cellular, PCS or any other network may benefit from a combination with the present invention. The invention may be practiced using the Internet and TCP/IP or TCP/UDP, over public switched telephone networks or over a private data network.

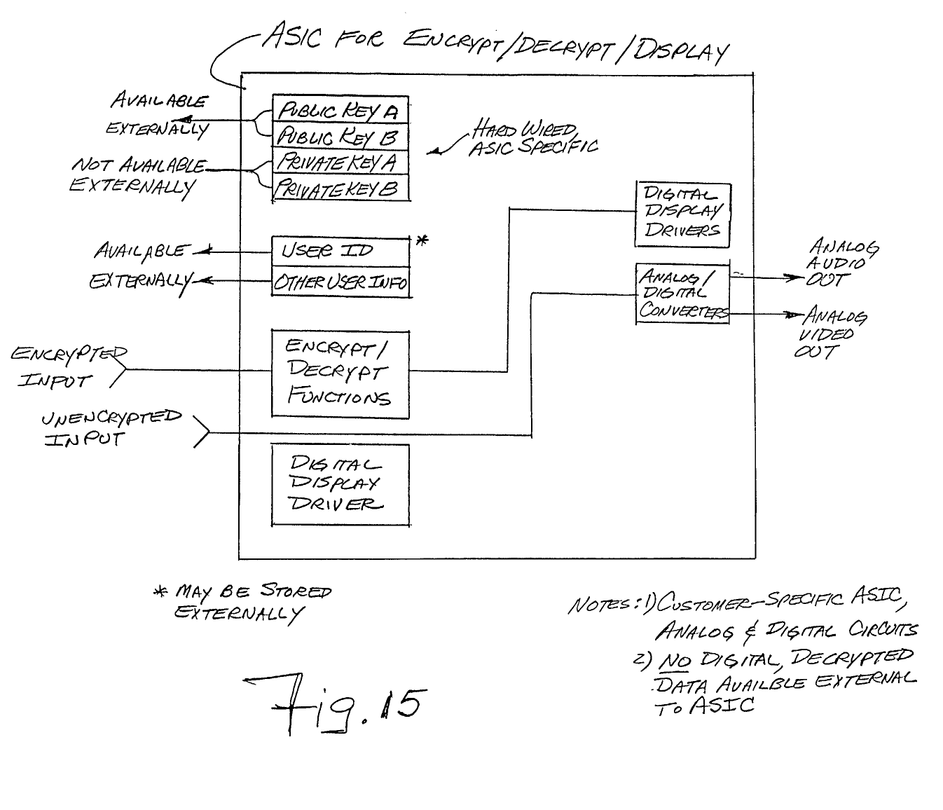

FIG. 14 is a list of functions embodied in the present invention, presented in blocks as a convenient catalogue of system server functions.

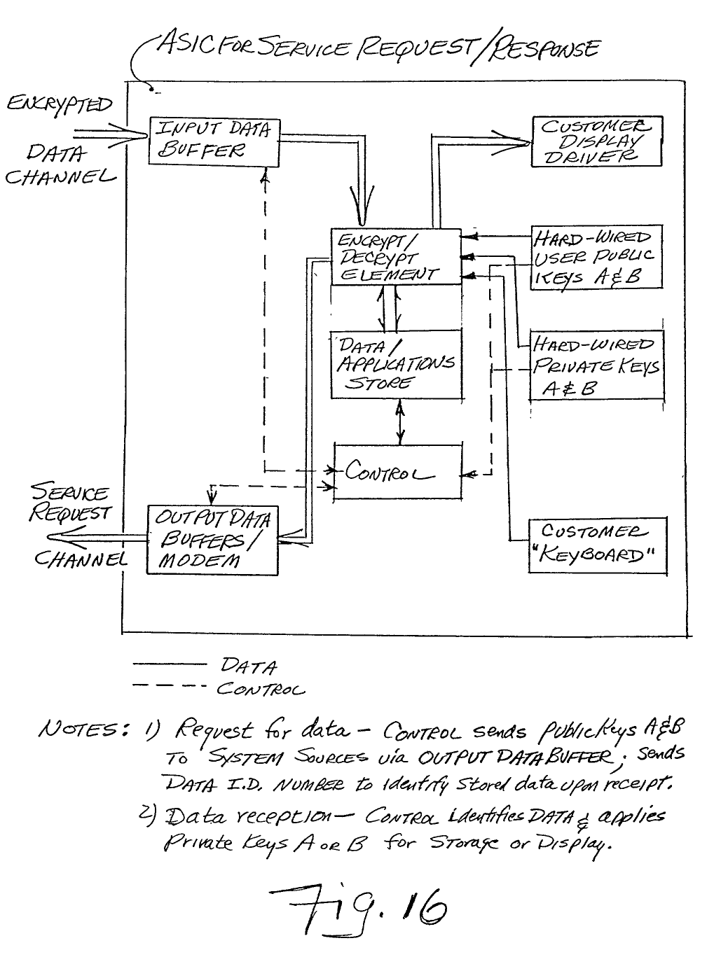

FIG. 15 is a block diagram of the customer specific, application specific integrated circuit (ASIC) for encryption, decryption and display of data at a customer's site which shows that no digital, decrypted data is available external to the ASIC which prevents copying the digital data.

FIG. 16 is a block diagram of an application specific integrated circuit (ASIC) for handling service requests and responses at a customer's site.

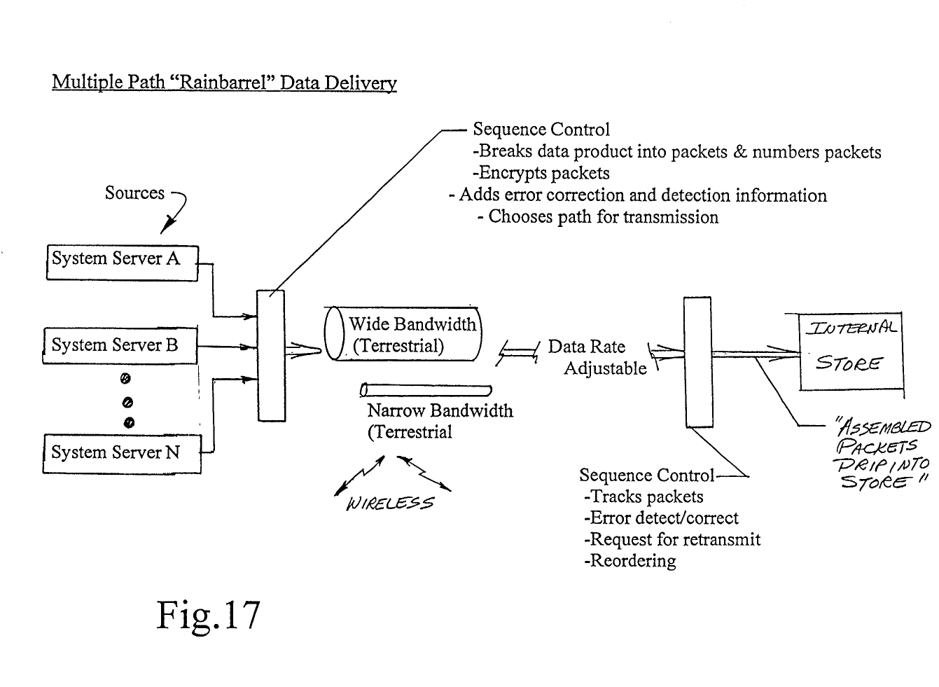

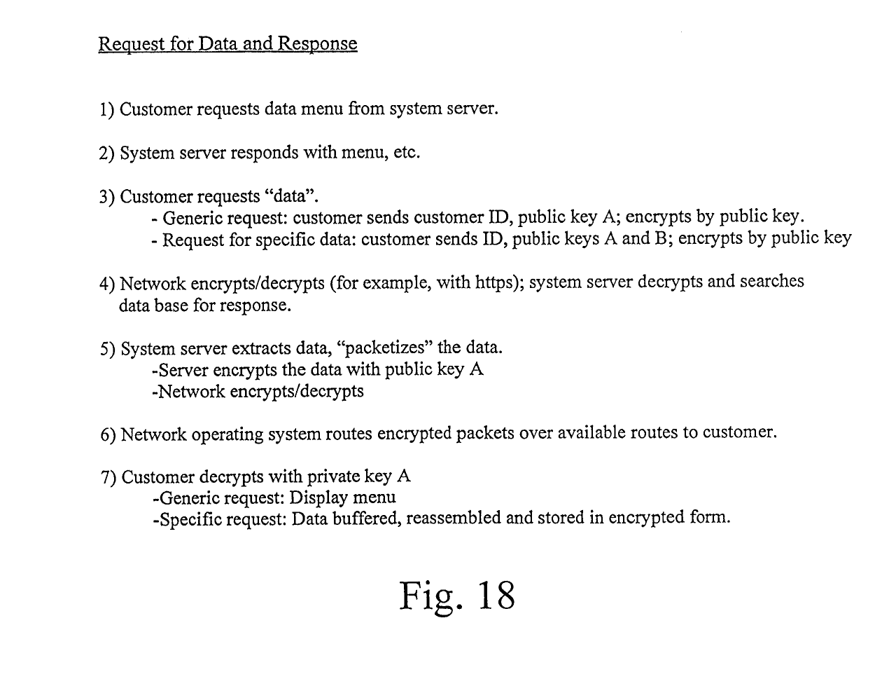

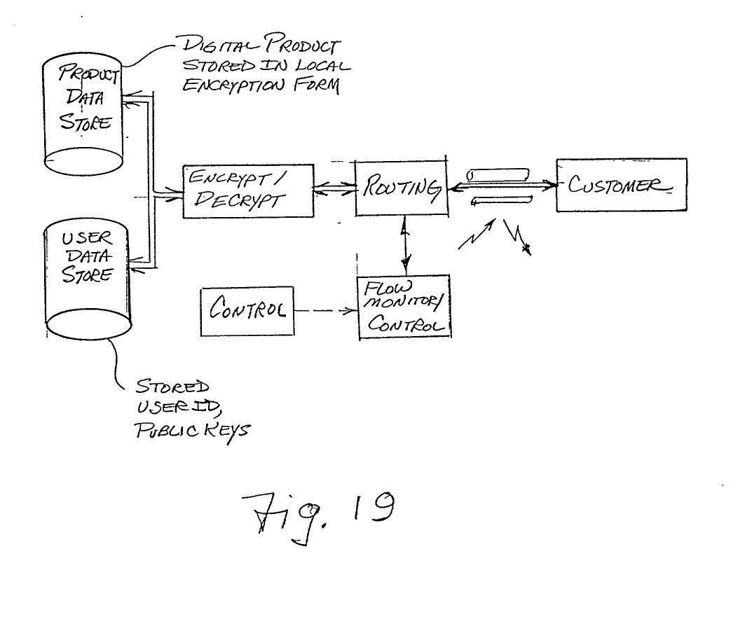

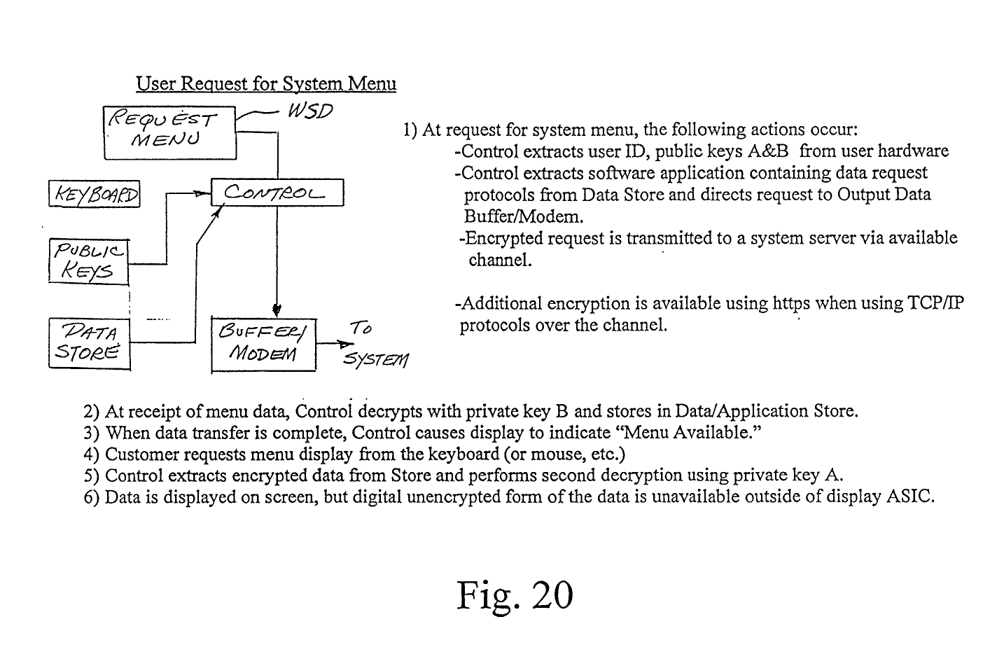

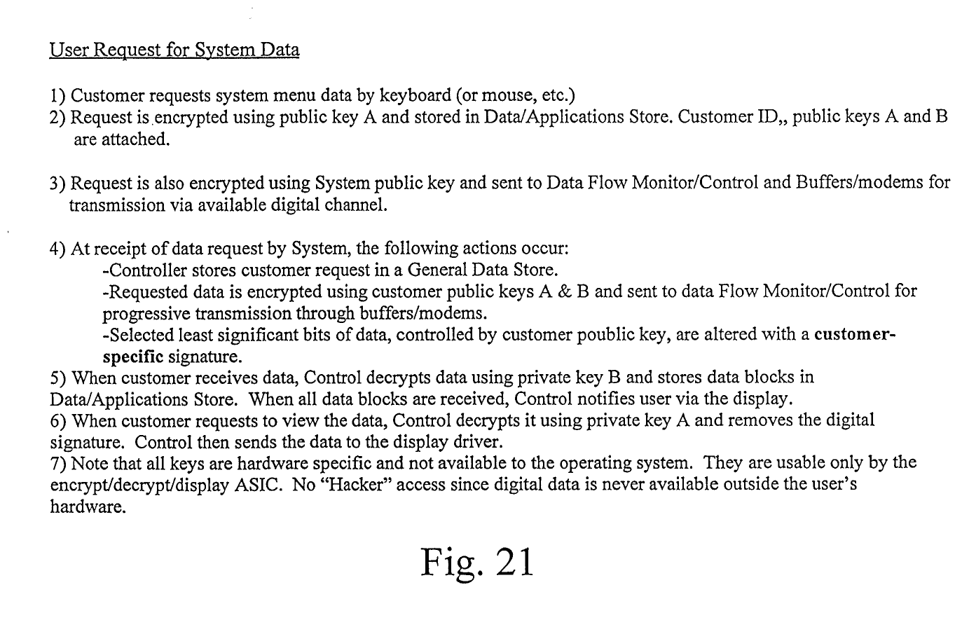

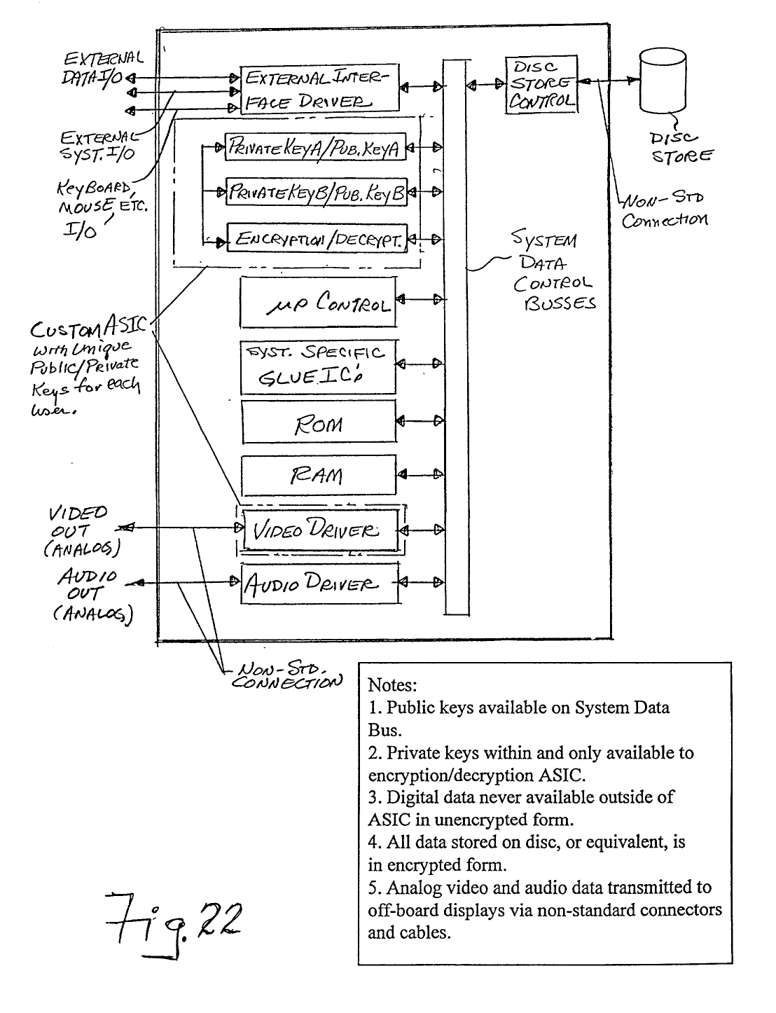

FIG. 17 is a schematic diagram illustrating the “Rainbarrel” data delivery scheme of the present invention. In this method, requested data is delivered to a customer in packets which are reassembled and “drip” into storage at the customer's site over a period of time. FIG. 18 is a list of steps which occur when a customer requests data from the system server. FIG. 19 is a flow diagram depicting the steps by which digital product stored at the system server is delivered through a selected network to a customer's site. FIG. 20 is a flow diagram illustrating the steps by which a user requests a system menu. FIG. 21 is a list of steps which occur when a customer requests system data from a system menu.

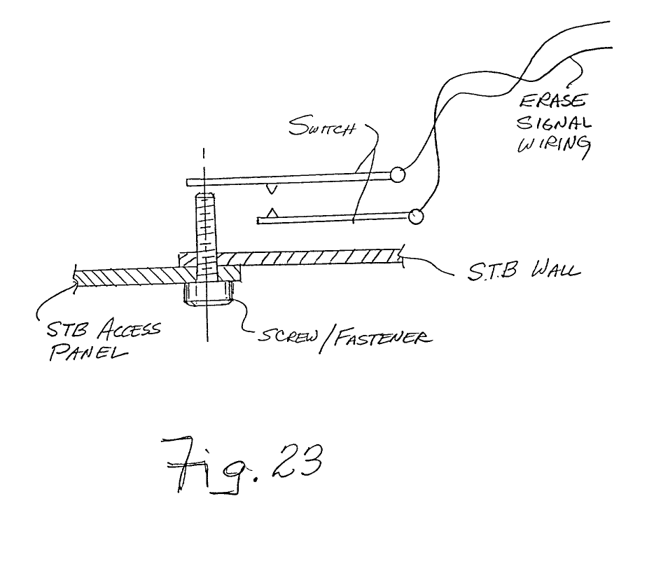

FIG. 22 is a block diagram of the circuit board in the customer's set-top box illustrating the functions, inputs and outputs of the circuit board.

FIG. 23 presents a partial cross-section ofthe exterior tamper-proof container of the set-top box, indicating a typical fastener switch which causes an erasure of all digital data stored in the box when the fastener is removed (as by tampering).

### CONCLUSION

Although the present invention has been described in detail with reference to one or more preferred embodiments, persons possessing ordinary skill in the art to which this invention pertains will appreciate that various modifications and enhancements maybe made without departing from the spirit and scope of the Claims that follow. The various alternatives for providing a highly secure data distribution system that have been disclosed above are intended to educate the reader about preferred embodiments of the invention, and are not intended to constrain the limits of the invention or the scope of Claims. The List of Reference Characters which follow is intended to provide the reader with a convenient means of identifying elements of the invention in the Specification and Drawings. This list is not intended to delineate or narrow the scope of the Claims.

### LIST OF REFERENCE CHARACTERS

A Aircraft

ANT Antenna

B Boat

C Car

DSL Direct subscriber link to a network

G Ground station

IC Interactive controller

OB Office building

POTS Public telephone service

R Residence

S Wireless signals

t Time related to satellite orbital position

SAT Satellite

STB Set-top box

WSD Wide screen display

10 Data stream in a fully utilized network data channel

12 Data stream in a partially utilized network data channel

14 Program material provided by the present invention and inserted in a partially utilized network data channel

20 Data transfer to customer by satellite, terrestrial and wireless systems

22 Satellite

24 Satellite distribution system to system server

26 System server

28 Data system; interactive or origin

30 Data encryption/decryption functions

32 Wireless distribution system (WDS)

34 Satellite distribution system to customers

36 Terrestrial distribution system (TDS)

38 Equipment at customer's site

40 Customer's wide screen display

42 Low rate, secure data accumulator

44 Real-time playback from storage to display screen

50 Customer's encrypted data storage

52 Customer's data encryption/decryption functions

54 Customer's input/output and display functions

56 System server data encryption/decryption functions

58 System server data control

60 System server data repository

70 Customer's steerable or “tracking” antenna

72 Customer's fixed antenna

74 System ground station omni-directional antenna

80 Secure connectors

82 Secure cables between customer's equipment components

What is claimed is:

1. A method comprising the steps of:
utilizing the excess capacity of a network by conveying data over said network during a period of less than maximum usage;
receiving said data during said period of less than maximum usage;
accumulating said data over an extended period of time; and
retrieving said data for on-demand use at a time after said extended period of time.

2. A method as recited in claim 1, in which said network includes a satellite.

3. A method as recited in claim 2, in which said satellites operate in low Earth orbit.

4. A method as recited in claim 2, in which said satellites operate in medium Earth orbit

5. A method as recited in claim 2, in which said satellites operate in high Earth orbit.

6. A method as recited in claim 2, in which said satellites operate in geosynchronous Earth orbit.

7. A method as recited in claim 2, in which said satellites operate in mid Earth orbit.

8. A method as recited in claim 2, in which said network includes a sub-orbital platform.

9. A method as recited in claim 2, in which said network includes a terrestrial wired network.

10. A method as recited in claim 2, in which said network includes a terrestrial wireless network.

11. A method as claimed in claim 10, further including the step of transmitting said data by television broadcast stations on existing channels; said data being inserted into picture scan lines.

12. A method as claimed in claim 10, further including the step of transmitting said data by television broadcast stations on existing channels; said data being inserted into scan lines corresponding to a Vertical Blanking Interval (VBI).

13. A method as claimed in claim 10, further including the step of transmitting said data by television broadcast stations on existing channels; said data being inserted into subcarriers in a composite baseband of television signals, of zero to 120 kilohertz.

14. A method as claimed in claim 10, further including the step of transmitting said data by television broadcast stations on existing channels; said data being inserted into other signals in a composite baseb and of television signals, of zero to 120 kilohertz.

15. A method as claimed in claim 10, further including the step of transmitting said data by an AM radio broadcast station on an existing channel.

16. A method as claimed in claim 10, further including the step of transmitting said data by a FM radio broadcasting station on an existing channel.

17. A method as claimed in claim 15 in which the step of step of transmitting said data by an AM radio broadcast station on an existing channel includes the step of transmitting said data by signals not audible on ordinary consumer receivers.

18. A method as claimed in claim 15 in which the step of transmitting said data by an AM radio broadcast station on an existing channel includes the step of modulating a sub carrier at a center frequency of said channel.

19. A method as claimed in claim 16 in which the step of transmitting said data by an FM radio broadcast station on an existing channel includes the step of modulating a subcarrier at a center frequency of said channel.

20. An apparatus comprising:
transmission means for transmitting digitized packets of data over a network means for communicating said packets of data; said data being transmitted to a plurality of authorized users;
said transmission means including a gateway means;
said transmission means further including a relay means for receiving said plurality of digitized packets of data from said gateway means and for retransmitting during a time period when the total communications capacity of said relay means is not fully used;
a receiver means for collecting said plurality of digitized packets ofdata which are transmitted from said transmission means;
said receiver means including a storage means for accumulating said plurality of digitized packets of data incrementally over an extended period of time; and
retrieving and using said plurality of digitized packets of data after a generally full program has been accumulated.

21. The apparatus as claimed in claim 20 in which said transmission means includes television broadcast stations on existing channels; said data being inserted into picture scan lines.

22. The apparatus as claimed in claim 20 in which said transmission means include television broadcast stations on existing channels; said data being inserted into video scan lines corresponding to a Vertical Blanking Interval (VBI).

23. The apparatus as claimed in claim 20 in which said transmission means includes television broadcast stations transmitting on an existing channel; said data being inserted into a subcarrier in a composite baseband of television signals, of zero to 120 kilohertz.

24. The apparatus as claimed in claim 20 in which said transmission means includes an AM radio broadcast station transmitting on an existing channel.

25. The apparatus as claimed in claim 20 in which said transmission means includes a FM radio broadcasting station transmitting on an existing channel.

26. The apparatus as claimed in claim 24 in which said AM radio broadcast station transmits said data by signals not audible on ordinary consumer receivers.

27. The apparatus as claimed in claim 25 in which said FM radio broadcast station transmits said data by modulating a subcarrier at a center frequency of said channel.

28. The apparatus as claimed in claim 25 in which said FM radio broadcast station transmits said data by modulating a subcarrier at a center frequency of said channel.
